(19) United States
(12) Patent Application Publication
(10) Pub. No.: US 2025/0317754 A1
(43) Pub. Date: Oct. 9, 2025

(54) CELL ACTIVATION OR DEACTIVATION WITH A SERVICE BASED RADIO ACCESS NETWORK

(71) Applicant: QUALCOMM Incorporated, San Diego, CA (US)

(72) Inventors: Shankar KRISHNAN, Poway, CA (US); Karl Georg HAMPEL, Jersey City, NJ (US); Naeem AKL, Bridgewater, NJ (US); Prasada Veera Reddy KADIRI, San Diego, CA (US); Gavin Bernard HORN, La Jolla, CA (US)

(21) Appl. No.: 18/628,614

(22) Filed: Apr. 5, 2024

(51) Int. Cl. H04W 24/02; H04W 74/0833; H04W 76/10

(52) U.S. Cl. CPC H04W 24/02; H04W 74/0833; H04W 76/10

(57) ABSTRACT

Method and apparatus for cell activation or deactivation with a service based radio access network. The apparatus provides a cell configuration including one or more cells having an established association with an eDU. The apparatus obtains a request to alter a status of at least one cell of the one or more cells having the established association with the eDU. The apparatus provides an updated cell configuration in response to an alteration of the status of the at least one cell. The apparatus may establish a first network entity from a plurality of network entities as a primary network entity. The apparatus may establish at least a second network entity from the plurality of network entities as a secondary network entity. The apparatus may determine to alter the status of the at least one cell based at least on a priority associated with the request.

### TECHNICAL FIELD

The present disclosure relates generally to communication systems, and more particularly, to a configuration for cell activation or deactivation with a service based radio access network for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a network node. The device may be a processor and/or a modem at a network entity or the network entity itself. The apparatus provides a cell configuration including one or more cells having an established association with an enhanced distributed unit (eDU). The apparatus obtains a request to alter a status of at least one cell of the one or more cells having the established association with the eDU. The apparatus provides an updated cell configuration in response to an alteration of the status of the at least one cell.

In an aspect of the disclosure, a method, a computer-readable medium, and an apparatus are provided. The apparatus may be a device at a network node. The device may be a processor and/or a modem at a network node or the network node itself. The apparatus obtains a cell configuration including one or more cells having an established association with an enhanced distributed unit (eDU). The apparatus provides a request to alter a status of at least one cell of the one or more cells having the established association with the eDU. The apparatus obtains an updated cell configuration in response to an alteration of the status of the at least one cell.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example function split between a core network and a RAN.

FIG. 4B is a diagram illustrating example aspects of a cloud native platform for a wireless network that may include a merger of core network and RAN services, in accordance with various aspects of the disclosure.

FIG. 5 illustrates an example functional split between the core network and the RAN, in accordance with various aspects of the disclosure.

FIG. 6A illustrates an example of cell activation/deactivation in 5G networks.

FIG. 6B illustrates an example of cell activation/deactivation in 6G networks.

FIG. 7 illustrates an example of intra-node cell activation/deactivation.

FIG. 8 illustrates an example of inter-node cell activation/deactivation.

FIG. 9 illustrates an example of intra-node cell activation in 6G networks.

FIG. 10A illustrates an example of coordination across multiple cell control services.

FIG. 10B illustrates another example of coordination across multiple cell control services.

FIG. 11 illustrates a first example of a call flow diagram illustrating an example of cell activation/deactivation.

FIG. 12 illustrates a second example of a call flow diagram illustrating an example of cell activation/deactivation.

FIG. 13 illustrates a third example of a call flow diagram illustrating an example of cell activation/deactivation.

FIG. 14 is a flowchart of a method of wireless communication.

FIG. 15 is a flowchart of a method of wireless communication.

FIG. 16 is a diagram illustrating an example of a hardware implementation for an example network entity.

FIG. 17 is a flowchart of a method of wireless communication.

FIG. 18 is a flowchart of a method of wireless communication.

FIG. 19 is a diagram illustrating an example of a hardware implementation for an example network entity.

### DETAILED DESCRIPTION

In wireless communications, cell activation or deactivation procedures are utilized as network energy saving purposes, while allowing for intra-radio access technology (RAT)/system and inter-RAT/system cell activation/deactivation procedures. The cell activation/deactivation procedures may allow for a RAN node owning a capacity booster cell to switch off a cell in instances where demand for capacity is reduced, and for a coverage cell to request for reactivation of such capacity booster cells in instances where there is an increase in demand for capacity. In wireless networks based on 5G, multiple entities may be allowed to request for cell activation, deactivation, or reactivation. For example, a CU-CP can request for DU to activate or deactivate its own served cells, CU-CP may request a peer CU-CP to reactivate one or more cells that were previously switched off, or an operation, administration, and management (OAM) may request a DU to activate or deactivate its cells. In some instances, CU-CPs may be utilized as a router that may forward or eventually direct an inter-node cell activation or deactivation message to a corresponding DU(s), due in part to a lack of a direct DU-DU interface. Redundant exchange of information over point-to-point interfaces (e.g., XnAP and FIAP) may result in duplicate effort. For example, served cell information may be exchanged over both Xn and F1.

Aspects presented herein provide a configuration for a service based architecture (SBA) for cell activation or deactivation procedures in a wireless network having a service-based architecture, e.g., such as 6G wireless communication systems. For example, an eDU may obtain a request to alter the status of one or more cells from a network entity having an established association with the eDU, where signaling between the network entity and the eDU occurs via a service based interface (SBI). In some aspects, the request may be from a service in the service-based architecture such as a cell control service (CCS) that control activation/deactivation of cells and/or maintaining cell configurations. The service may also be referred to by different names than a CCS, in some aspects. For example, a service based interface (SBI) may be used to improve, or optimize, cell activation/deactivation procedures.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

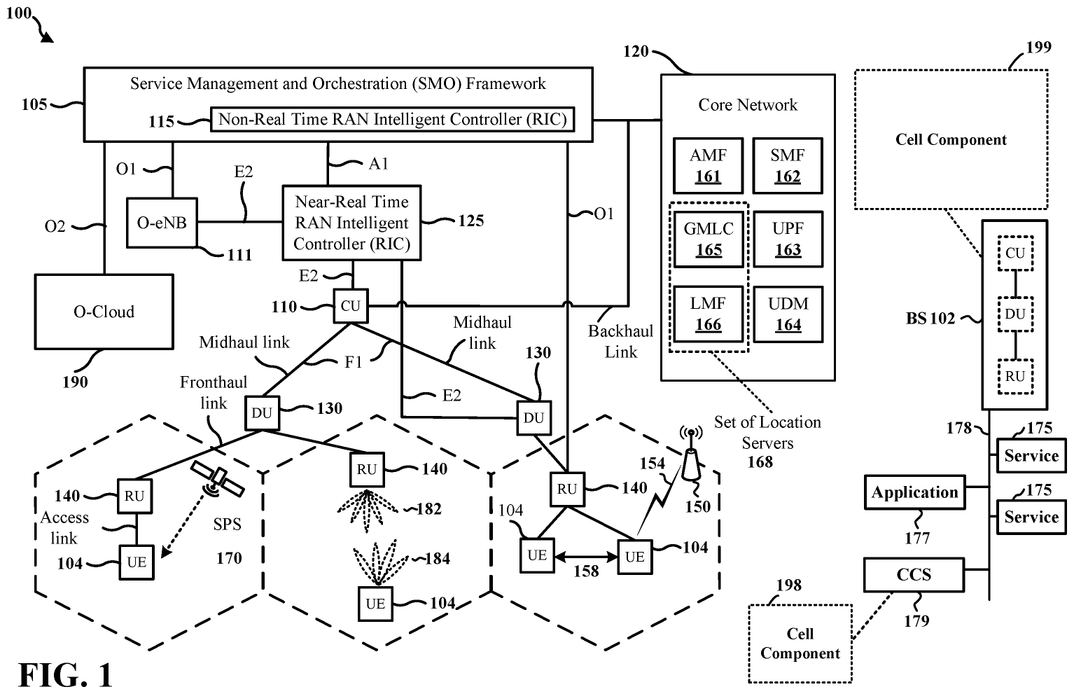

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

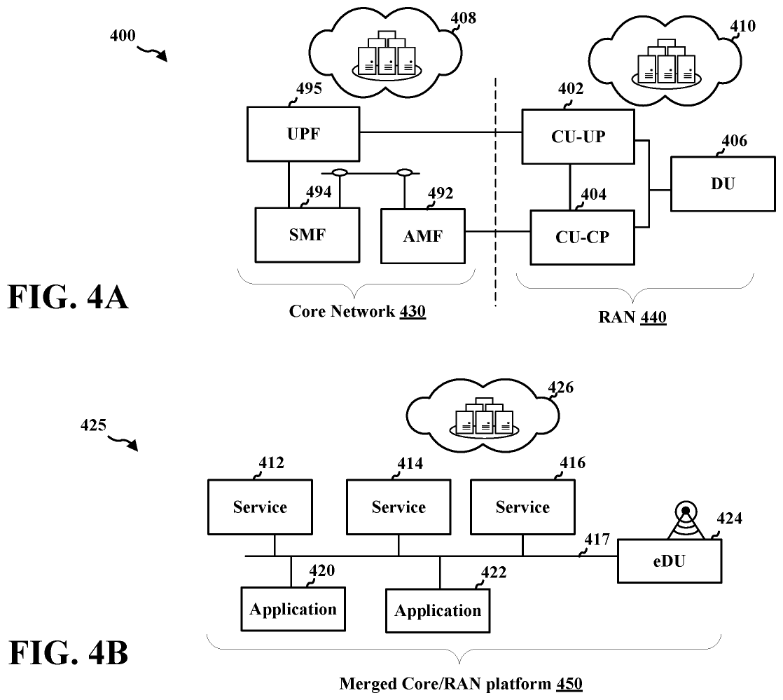

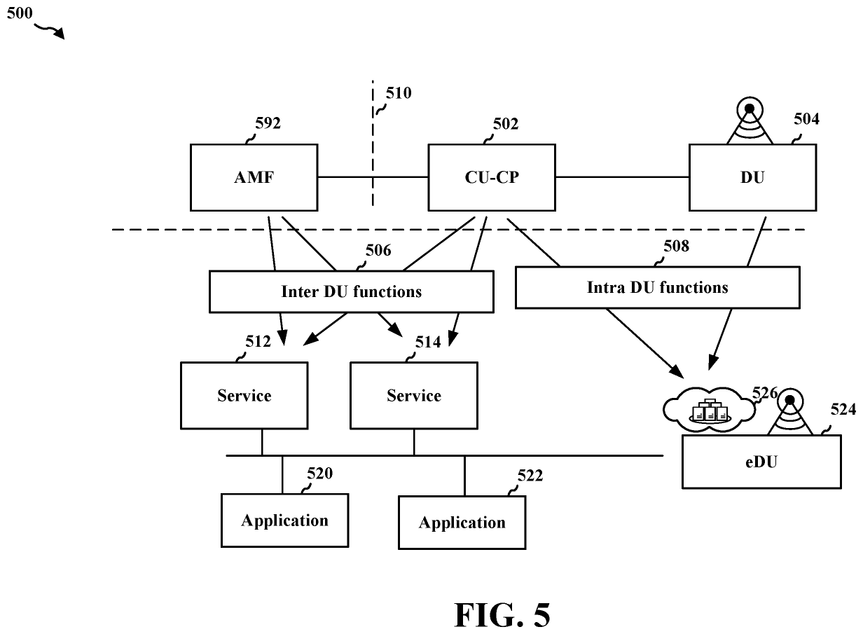

The base stations 102 configured for 5G NR (collectively referred to as Next Generation RAN (NG-RAN)) may interface with core network 120 through backhaul links. The radio nodes configured for 6G, or other service-based architectures, may have an API interface 178 with various services of the core network, such as described in connection with any of FIG. 4B or 5, for example. The service-based architectures may include services, e.g., as represented by services 175 and application 177. FIG. 1 illustrates a DU as an example radio node, although such radio nodes may also be referred to as an enhanced DU (eDU), a network node, a network entity, or by other names.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a service in a service based architecture, such as the CCS 179, may include a cell component 198 that may be configured to obtain a cell configuration including one or more cells having an established association with an eDU, provide a request to alter a status of at least one cell of the one or more cells having the established association with the eDU, and obtain an updated cell configuration in response to an alteration of the status of the at least one cell.

Referring again to FIG. 1, in certain aspects, a network node, such as one or more components of a base station 102, or an eDU, may include a cell component 199 that may be configured to provide a cell configuration including one or more cells having an established association with an eDU, obtain a request to alter a status of at least one cell of the one or more cells having the established association with the eDU, and provide an updated cell configuration in response to an alteration of the status of the at least one cell.

Although the following description may be focused on 5G NR, the concepts described herein may be applicable to other similar areas, such as LTE, LTE-A, CDMA, GSM, and other wireless technologies.

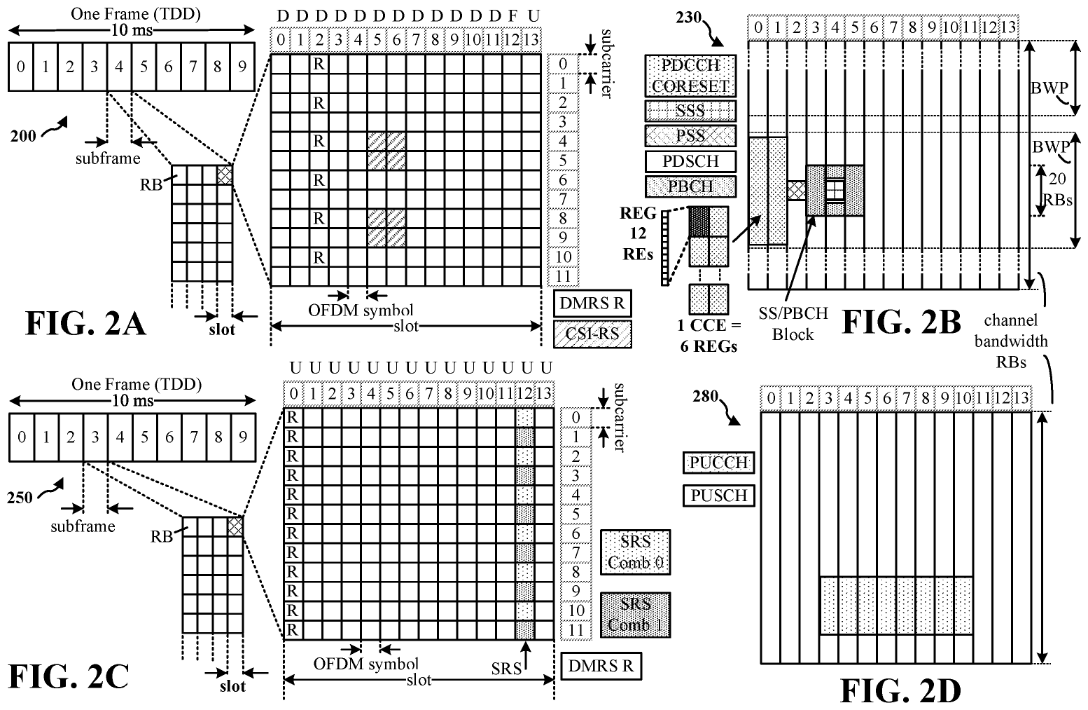

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δf = 2^{μ} · 15 | |
| μ | [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

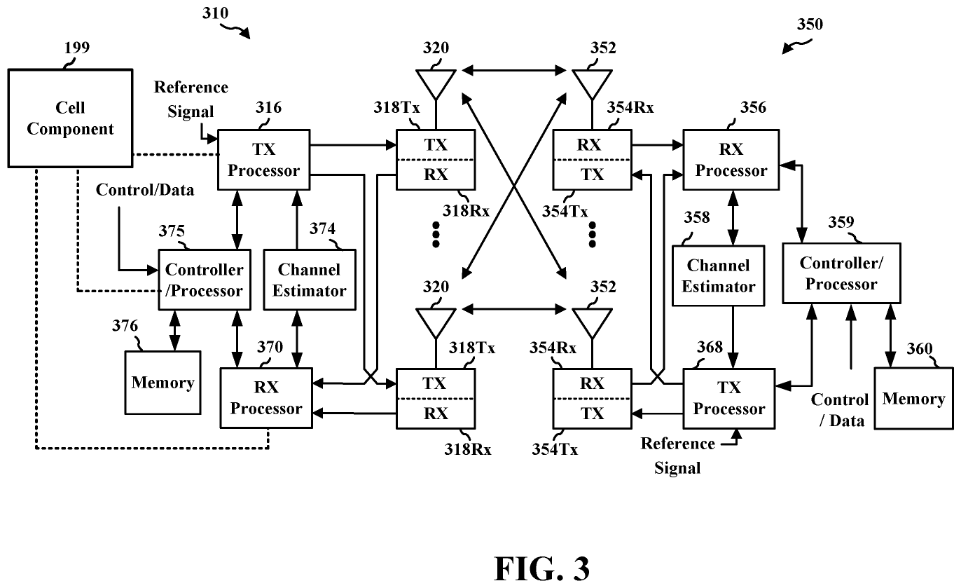

FIG. 3 is a block diagram of various components of a base station 310 (aspects of which may correspond to an eDU) in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the cell component 199 of FIG. 1.

FIG. 4A is a diagram 400 illustrating an example function split between a core network 430 and a RAN 440. FIG. 1 illustrates an example aspect of a core network (e.g., core network 120), and illustrates an example of a base station 102/180 as a RAN. FIG. 4A shows the UPF 495, SMF 494, and AMF 492 as part of the core network 430. FIG. 4A shows the CU-UP 402 (e.g., that provides user plane functionality), the CU-CP 404 (e.g., that provides control plane functionality), and the DU 406 provided as part of the RAN 440. The CU-CP and/or CU-UP may include aspects described for the CU 110 in FIG. 1. The DU 406 may include aspects described for the DU 130 in FIG. 1. Aspects of the core network/RAN hierarchy in FIG. 4A may be employed, e.g., in 3G, 4G, and/or 5G wireless networks, as an example. The functional split in FIG. 4A may help to maintain performance and security of a wireless network and accessibility of on-site equipment. FIG. 4A illustrates that some aspects of the core network 430 may include a cloud platform 408, and some aspects of the RAN 440 may include a cloud platform 410.

FIG. 4B is a diagram 425 illustrating example aspects of a cloud native platform (e.g., as shown at 426) for a wireless network that may include a merger (or combined functionality) of core network and RAN services. The platform may be referred to as a merged Core/RAN platform 450, for example. The combination of the functions between the core network and the RAN may simplify protocols and reduce duplication across the core network and RAN. FIG. 4B illustrates that services (which may include merged services that combine core network and RAN functionality) can be hosted in the wireless network based on a deployment topology and/or capabilities for each service's requirements. FIG. 4B illustrates multiple services 412, 414, and 416; multiple applications 420 and 422; and an eDU 424 as part of the merged Core/RAN platform 450. The platform enables each service 412 to be updated independently of the other services. The services provide various functions for the wireless network. Examples of services may include access control services, mobility services, PWS services, V2X services, MBS services, and positioning services, among other examples. The platform may use an API interface 417, for example.

FIG. 5 is a diagram 500 showing a converged service-based core network and RAN and shows that various functions performed by the core network (e.g., AMF 592) and the RAN (e.g., CU-CP 502 and/or the DU 504) can be distributed across the service-based platform described in connection with FIG. 4B. FIG. 5 illustrates an example functional split 510 between the core network (e.g., 592) and the RAN (e.g., 502 and 504). As illustrated by the arrows, various aspects of the inter-DU functions 506 that are performed by the AMF 592 and/or the CU-CP 502 can be performed by different services 512 and 514 in the service-based architecture. FIG. 5 illustrates that intra-DU functions 508 performed by the CU-CP 502 and/or the DU 504 can be performed by the eDU 524 (as an example of a network node or radio node) using the cloud based architecture 526. FIG. 5 also illustrates that the service-based architecture may include one or more applications 520 and 522.

The converged service-based core network and RAN may include a single cloud platform to host application(s), and the core network and RAN services, for example. The architecture can extend the benefits of a service-based architecture to the RAN. The architecture may enable benefits relating to a cloud based system, e.g., including scalability, elasticity, resilience, reuse, agility, visibility, automation, and/or protection in case of failure, among other benefits. Each service (e.g., 412 or 512) can be scaled independently, and resources can be increased or decreased for individual services.

The functional split (e.g., as shown at 510) for the core network and RAN can be adjusted in order to leverage cloud deployments (e.g., in comparison to an appliance centered architecture). Such cloud platforms enable a redistribution of services or functions of the core network and RAN, and enables applications to share the common platform. The cloud based architecture enables real-time link management to the RAN edge. Adaptation at the DU, e.g., eDU or radio node, enables more efficient activation/deactivation/selection of features based on the intended user experience.

In wireless communications, cell activation or deactivation procedures can be utilized for network energy saving purposes, while allowing for intra-RAT/system and inter-RAT/system cell activation/deactivation procedures. The cell activation/deactivation procedures may allow for a RAN node owning a capacity booster cell to switch off a cell in instances where demand for capacity is reduced, and for a coverage cell to request for reactivation of such capacity booster cells in instances where there is an increase in demand for capacity. In 5G, for example, multiple entities may be allowed to request for cell activation, deactivation, or reactivation. For example, a CU-CP can request for DU to activate or deactivate its own served cells, CU-CP may request a peer CU-CP to reactivate one or more cells that were previously switched off, or an OAM may request a DU to activate or deactivate its cells. In some instances, CU-CPs may be utilized as a router that may forward or eventually direct an inter-node cell activation or deactivation message to a corresponding DU(s), due in part to a lack of a direct DU-DU interface. Redundant exchange of information over point-to-point interfaces (e.g., XnAP and FIAP) may result in duplicate effort. For example, served cell information may be exchanged over both Xn and F1.

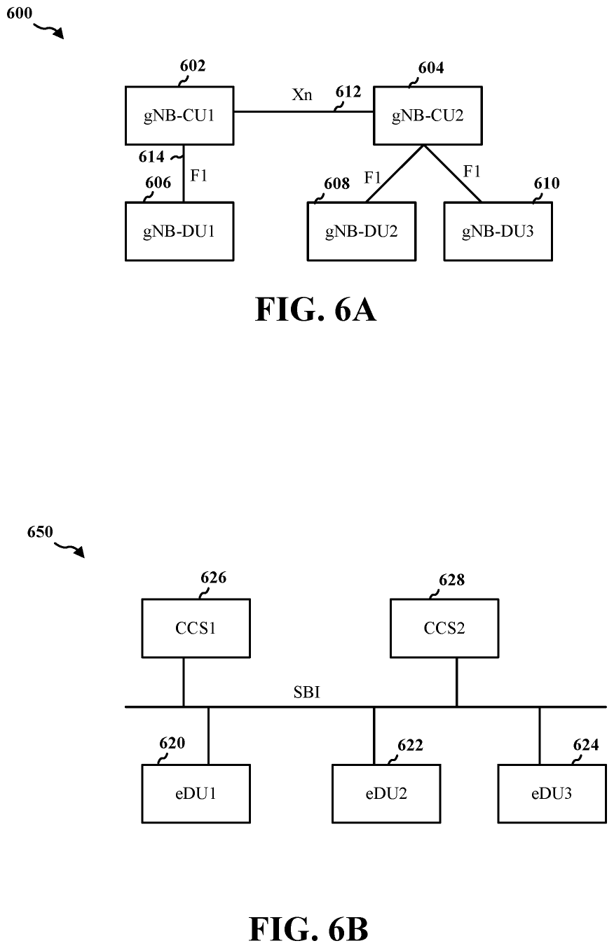

In 5G systems, as shown for example in diagram 600 of FIG. 6A, a gNB-DU 606, 608, or 610 provides the configuration of its served cells to a gNB-CU 602 or 604 via F1AP 614, which can then be forwarded to neighboring gNB-CU(s) 604 via XnAP 612. In the diagram 600 of FIG. 6A, a gNB-DU may only connect to a single gNB-CU. The gNB-CU may request the gNB-DU to activate cells or to deactivate cells.

In some instances, a gNB-CU may request to reactivate cells that are associated with a peer gNB-CU.

In wireless communication systems having a service-based architecture, such as 6G systems, as shown for example in diagram 650 of FIG. 6B, a service (e.g., cell control service (CCS) 626 or 628) may be configured to obtain cell configurations from an eDU(s) (e.g., 620, 622, and/or 624) and may be further configured to decide on cell activation or deactivation of cells associated with the eDU(s). An eDU may potentially connect to multiple services (e.g., CCSs) via the SBI. In some instances, the service (e.g., CCS 626 or 628) may request the eDU to activate certain cells or to deactivate certain cells.

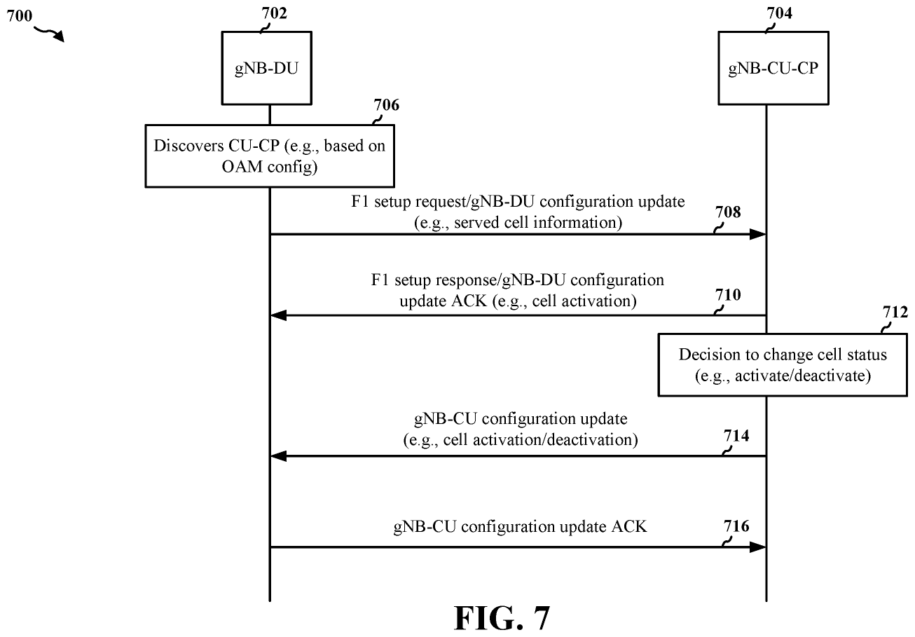

FIG. 7 is a diagram 700 showing an example of an intra-node cell activation/deactivation in 5G systems. At 708, a gNB-DU 702 may provide configuration information to a gNB-CU-CP 704 after discovering the gNB-CU-CP 704, at 706. The gNB-DU 702 may discover the gNB-CU-CP based on an OAM configuration. The gNB-CU-CP 704 may provide, to the gNB-DU 702, an acknowledgment (ACK) in response to the configuration information, at 710. The gNB-CU-CP 704 may determine to change the cell status, at 712, such that the gNB-CU-CP 704 may decide to activate or deactivate the cell associated with the gNB-DU 702. At 714, the gNB-CU-CP 704 may send, to the gNB-DU 702, a request to alter the status of the cell (e.g., activate, deactivate). The gNB-DU 702 may respond with an ACK to acknowledge the request to change the status of the cell, at 716.

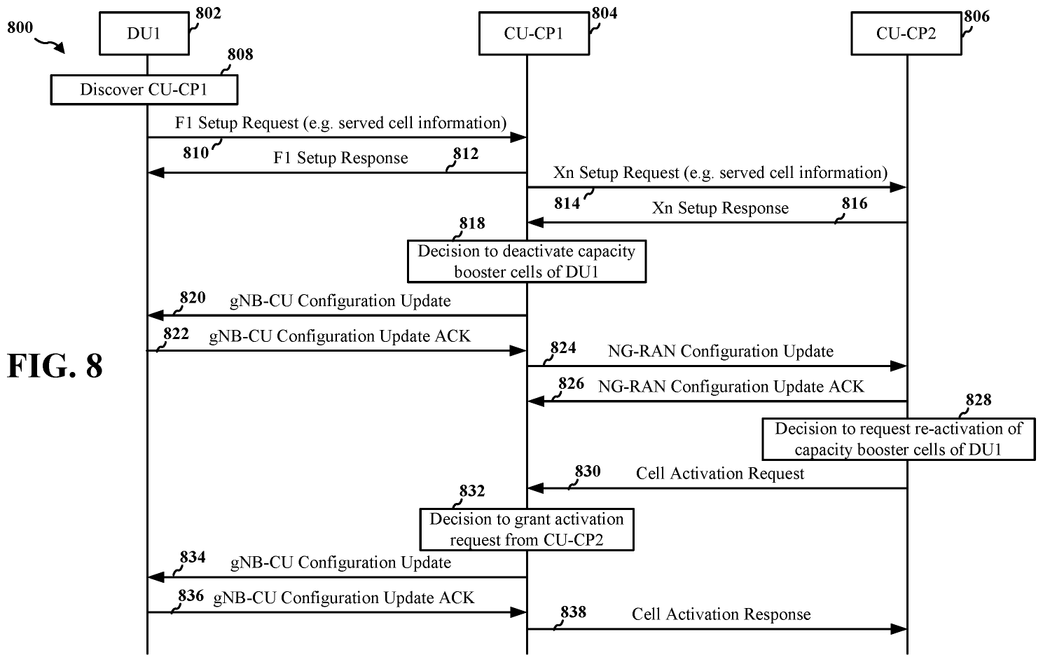

FIG. 8 is a diagram 800 showing an example of an inter-node cell activation/deactivation in 5G systems. In some instances, a CU-CP1 804 may be configured to manage capacity booster cells and may be configured to autonomously decide to alter the status of the capacity booster cells based on capacity demands. For example, following discovery and set up shown at 808, 810, 812, 814, and 816, the CU-CP1 804 may determine to deactivate the capacity booster cells, at 818, if demand decreases, or may determine to activate the capacity booster cells if demand increases. FIG. 8 illustrates the CU-CP1 sending a configuration update at 820 to the DU 802 and receiving an ACK at 822. In such instances, all the neighbor nodes may be informed of the change of status of the cells. The neighbor nodes may be informed of the change of the status of the cells via an Xn interface, as shown at 824, and receive an ACK at 826. In some aspects, a CU-CP2 806 may be configured to manage coverage cells and may be configured to request cell reactivation based on capacity needs, e.g., as shown at 828, 830, 832, 834, 836, and 838. The reactivation of the cells may be achieved via a cell activation procedure. In some instances, all of the peer network entities may be informed by the network entity configured to manage the capacity booster cell regarding the reactivation of the capacity booster cells.

Aspects presented herein provide a configuration for a service based architecture (SBA) for cell activation or deactivation procedures in a wireless communication system having service-based architecture, such as 6G systems. For example, an eDU may obtain a request to alter the status of one or more cells from a network entity having an established association with the eDU. At least one advantage of the disclosure is that SBI may be utilized for the SBA cell activation or deactivation procedures.

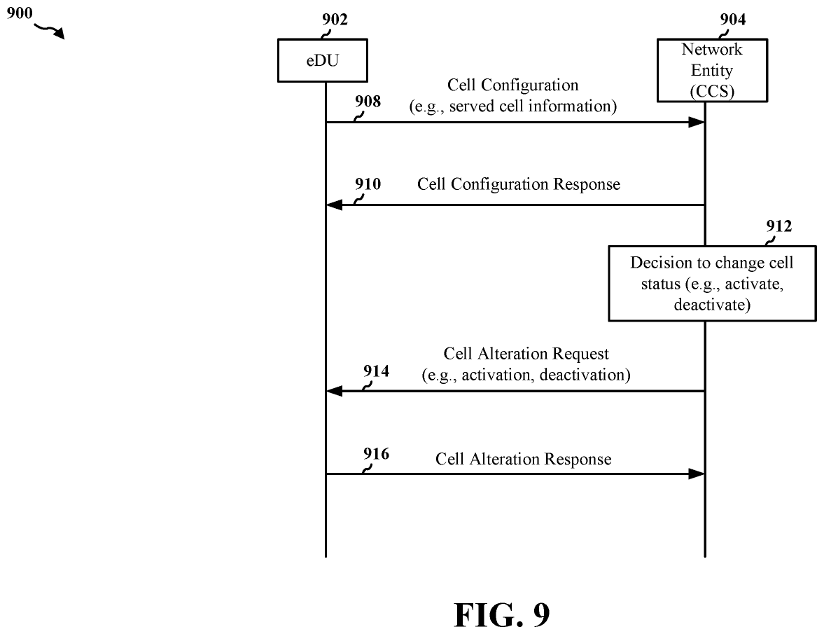

FIG. 9 is a diagram 900 showing an example of an intra-node cell activation in a wireless communication system having service-based architecture, such as described in connection with any of FIGS. 4B, 5, and 6B. In some aspects, the wireless communication system may be a 6G system. In the diagram 900 of FIG. 9, an eDU 902 may provide, to a network entity 904 such as a CCS, a cell configuration indicating the served cell information, at 908. For example, the network entity may be a service in the service-based architecture that activates/deactivates cells and/or manages cell configurations. The network entity 904 may respond, at 910, with a cell configuration response to acknowledge the cell configuration. In some instances, the network entity 904 may decide to change the cell status of the cells associated with the eDU 902. For example, the network entity 904 may determine to activate or deactivate one or more cells associated with the eDU 902, as shown at 912. In such instances, the network entity 904 may provide, to the eDU 902, a cell alteration request, at 914, to activate or deactivate the one or more cells associated with the eDU 902. The eDU 902, in response to the request, may provide a cell activation response to acknowledge the cell activation request, at 916. The cell activation or deactivation procedure in the example of FIG. 9 may include aspects similar to the cell activation or deactivation procedure in the example of FIG. 7, where a main distinction between the two procedures is that the procedure in the example of FIG. 9 is performed with SBI based application programming interfaces (APIs) in a service-based networks.

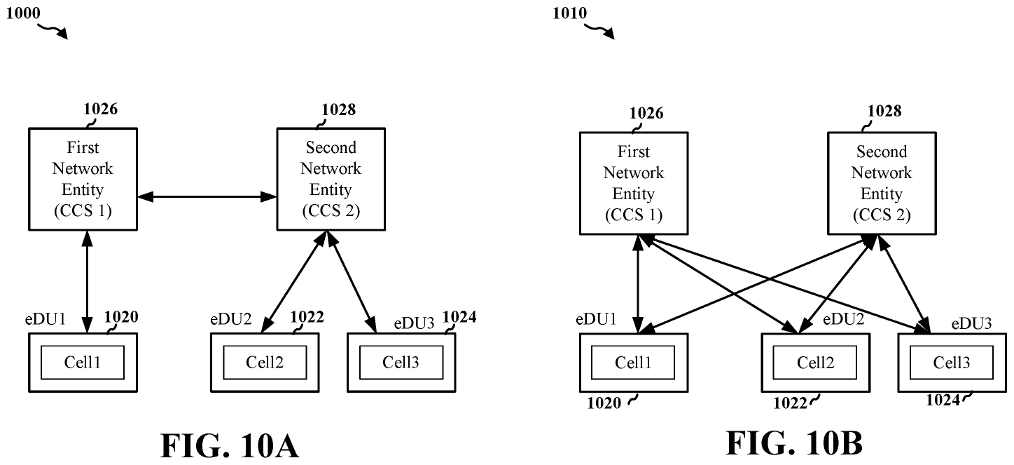

FIGS. 10A and 10B provide example diagrams 1000, 1010 of coordination across multiple network entities (e.g., multiple CCSs) that are configured to control cell services. In the example of FIG. 10A, the diagram 1000 includes a first network entity 1026 (e.g., a first CCS) and a second network entity 1028 (e.g., a second CCS). The first network entity 1026 may have an association with a first cell (e.g., cell1) that is provided via a first eDU 1020 (e.g., eDU1). The second network entity 1028 may have an association with a second cell (e.g., cell2) that is provided via a second eDU 1022 (e.g., eDU2) and may have an association with a third cell (e.g., cell3) that is provided via a third eDU 1024 (e.g., eDU3). In the example of diagram 1000 in FIG. 10A, each eDU may communicate with a single network entity configured to control cell service. For example, eDU1 may only communicate with the first network entity and may not communicate with the second network entity, while eDU2 and eDU3 may only communicate with the second network entity and may not communicate with the first network entity.

In the example of FIG. 10B, the diagram 1010 also includes a first network entity 1026 and a second network entity 1028. However, each of the first network entity and the second network entity may have an association with a first cell (e.g., cell1) via a first eDU (e.g., eDU1), an association with a second cell (e.g., cell2) via a second eDU (e.g., eDU2), and an association with a third cell (e.g., cell3) via a third eDU (e.g., eDU3). In the example of diagram 1010, the first and second network entities are in a mesh-based configuration, such that an eDU may communicate with multiple network entities configured to control cell service.

In some aspects, in the example in FIG. 10A without mesh support, a CCS to which the eDU has an association may make a final determination about cell activation and/or deactivation. In some aspects, with a mesh deployment, as in FIG. 10B, a primary CCS may make a final determination about cell activation and/or deactivation. In some aspects, with a mesh deployment, as in FIG. 10B, an eDU may make the final determination about cell activation and/or deactivation.

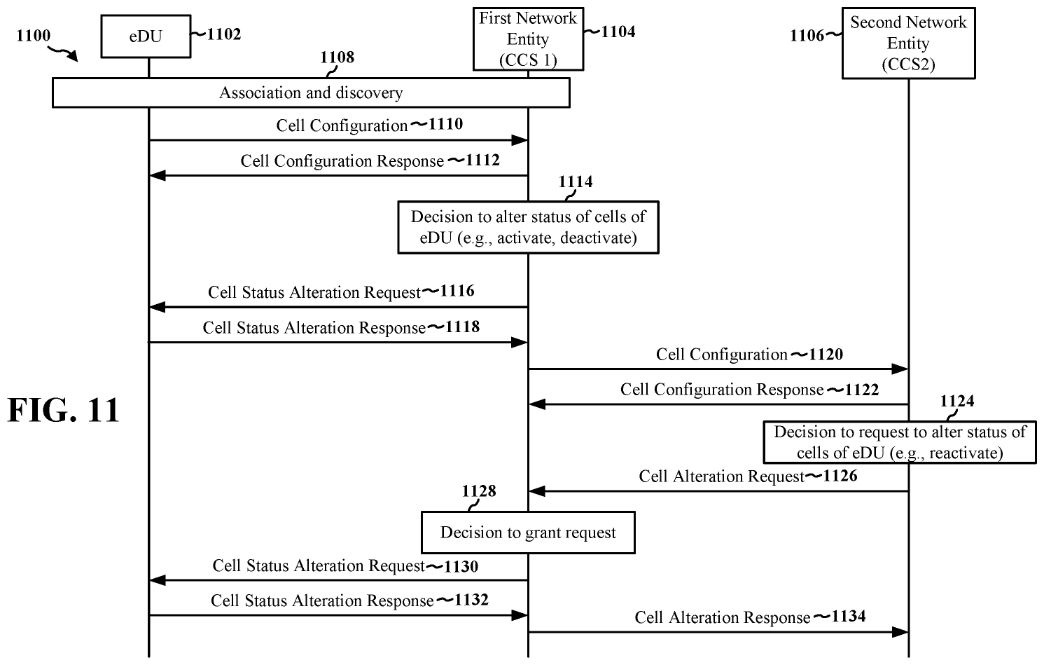

FIG. 11 is a diagram 1100 illustrating an example of a cell activation/deactivation procedure. The diagram 1100 may include an eDU 1102, a first network entity 1104 (e.g., a first CCS), and a second network entity 1106 (e.g., a second CCS). At 1108, an association and discovery procedure may occur between the eDU and the first network entity, such that the eDU discovers the first network entity and an association between the eDU and the first network entity is established. In the example of diagram 1100, only a single eDU-network entity association may be allowed.

At 1110, the eDU may provide the first network entity with a cell configuration. The first network entity may obtain the cell configuration from the eDU. The eDU may provide the cell configuration to the first network entity after establishing the association with the first network entity. At 1112, the first network entity may provide a cell configuration response (e.g., ACK) to the eDU.

At 1114, the first network entity may decide to alter the status of one or more cells associated with the eDU. For example, the first network entity may decide to activate or deactivate the one or more cells of the eDU based at least one capacity usage. At 1116, the first network entity provides a cell status alteration request to the eDU. The eDU may obtain the cell status alteration request from the first network entity. At 1118, the eDU may provide a cell status alteration response to the first network entity which may acknowledge the request from the first network entity. The first network entity may obtain the cell status alteration response from the eDU. In some instances, the first network entity may inform peer network entities (e.g., second network entity 1106) of the change in status of the one or more cells of the eDU. For example, at 1120, the first network entity may provide a cell configuration that includes the change in the status of the one or more cells of the eDU to the second network entity. The second network entity may obtain the cell configuration that includes the change in the status of the one or more cells of the eDU from the first network entity. At 1122, the second network entity may provide a cell configuration response to the first network entity.

In some aspects, the peer network entity may request for a cell re-activation if additional capacity is needed to accommodate capacity demands. In such instances, at 1124, the peer network entity (e.g., second network entity) may decide to request to alter the status of the one or more cells of the eDU, such that the second entity may request to reactivate the one or more cells of the eDU. At 1126, the second network entity may provide a cell alteration request to the first network entity. The second network entity is unable to directly request the eDU to alter the status of the one or more cells of the eDU, due to the lack of association established between the second network entity and the eDU. The second network entity would need to provide the request to the network entity having an established association with the eDU. The first network entity may obtain the cell alteration request from the second network entity. At 1128, the first network entity may determine whether to grant the request to alter the status of the one or more cells of the eDU. The first network entity may determine to grant or deny the request based on capacity needs of the first network entity that may have priority over the secondary network entity (e.g., second network entity).

At 1130, the first network entity may provide or forward a cell status alteration request to the eDU. The first network entity provides or forwards the cell status alteration request from the second network entity to the eDU. At 1132, the eDU may provide a cell status alteration response that acknowledges the request to the first network entity. The first network entity obtains the cell status alteration response from the eDU. The cell status alteration response indicates the alteration of the one or more cells based on the request, such that the one or more cells have been reactivated based on the cell status alteration request obtained from the first network entity that is based on the cell alteration request provided to the first network entity from the second network entity. At 1134, the first network entity provides a cell alteration response to the second network entity. The second network entity obtains the cell alteration response from the first network entity indicating that the one or more cells of the eDU have been reactivated based on the request from the second network entity.

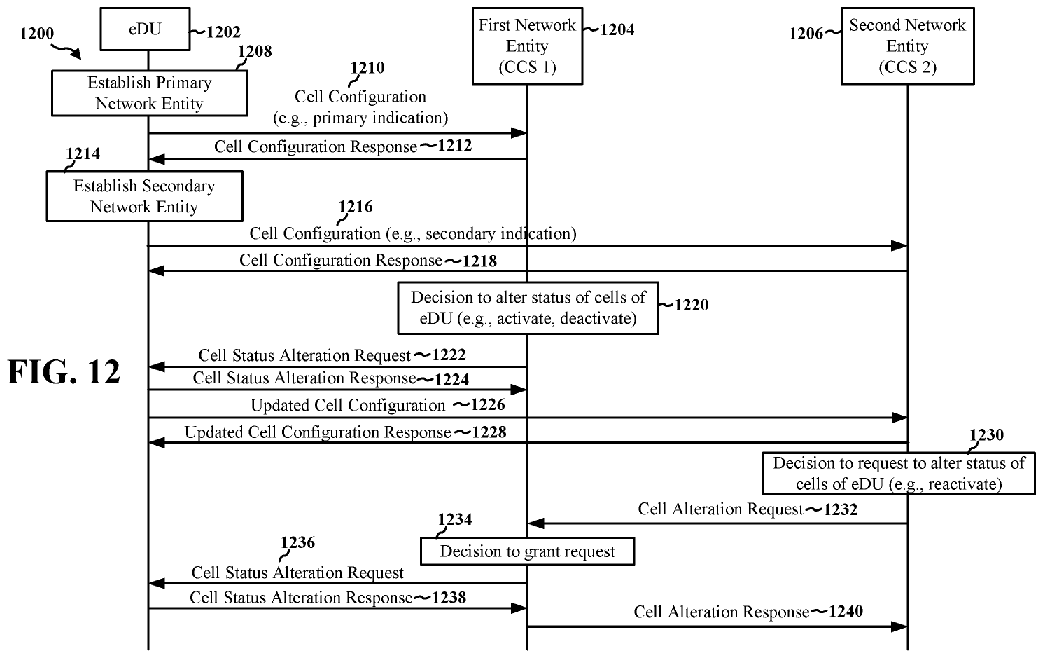

FIG. 12 is a diagram 1200 illustrating another example of a cell activation/deactivation procedure. The diagram 1200 may include an eDU 1202, a first network entity 1204 (e.g., a first CCS), and a second network entity 1206 (e.g., a second CCS). At 1208, the eDU may establish a primary network entity from a plurality of network entities. For example, the eDU may establish the first network entity as a primary network entity. In such instances, at 1210, the eDU may provide a cell configuration to the first network entity. The first network entity may obtain the cell configuration from the eDU. The cell configuration may indicate to the first network entity that the first network entity is established as the primary network entity. At 1212, the first network entity may provide a cell configuration response to the eDU, which acknowledges that cell configuration. The eDU may obtain the cell configuration response from the first network entity.

At 1214, the eDU may establish a secondary network entity from a plurality of network entities. For example, the eDU may establish the second network entity as a secondary network entity. In such instances, at 1216, the eDU may provide a cell configuration to the second network entity. The second network entity may obtain the cell configuration from the eDU. The cell configuration may indicate to the second network entity that the second network entity is established as the secondary network entity. In some aspects, the cell configuration may indicate that the first entity is established as the primary network entity. At 1218, the second network entity may provide a cell configuration response to the eDU, which acknowledges that cell configuration. The eDU may obtain the cell configuration response from the second network entity.

At 1220, the first network entity may decide to alter the status of one or more cells associated with the eDU. For example, the first network entity may decide to activate or deactivate the one or more cells of the eDU based at least one capacity usage. At 1222, the first network entity provides a cell status alteration request to the eDU. The eDU may obtain the cell status alteration request from the first network entity. At 1224, the eDU may provide a cell status alteration response to the first network entity which may acknowledge the request from the first network entity. The first network entity may obtain the cell status alteration response from the eDU. The eDU may inform the one or more secondary network entities of the change in status of the one or more cells of the eDU. For example, at 1226, the eDU may provide an updated cell configuration to the second network entity. The second network entity may obtain the updated cell configuration from the eDU which indicates the one or more cells that have been altered based on the request from the first network entity. At 1228, the second network entity may acknowledge the updated cell configuration and provide an updated cell configuration response to the eDU. The eDU may obtain the updated cell configuration response from the second network entity.

In some aspects, the secondary network entity (e.g., second network entity) may request for a cell re-activation if additional capacity is needed to accommodate capacity demands. In such instances, at 1230, the second network entity may decide to request to alter the status of the one or more cells of the eDU, such that the second entity may request to reactivate the one or more cells of the eDU. At 1232, the second network entity may provide a cell alteration request to the first network entity. The cell alteration request is provided to the first network entity since the first network entity is the primary network entity. The primary network entity processes the request from the secondary network entities and determine whether to grant or deny the request to reactivate the one or more cells of the eDU. The first network entity may obtain the cell alteration request from the second network entity. At 1234, the first network entity may determine whether to grant the request to alter the status of the one or more cells of the eDU. The first network entity may determine to grant or deny the request based on capacity needs of the first network entity that may have priority over the secondary network entity (e.g., second network entity).

At 1236, the first network entity may provide a cell status alteration request to the eDU. The first network entity provides the cell status alteration request based on the request from the second network entity to the eDU. At 1238, the eDU may provide a cell status alteration response that acknowledges the request to the first network entity. The first network entity obtains the cell status alteration response from the eDU. The cell status alteration response indicates the alteration of the one or more cells based on the request from the first network entity, such that the one or more cells have been reactivated based on the cell status alteration request granted by the first network entity that is based on the cell alteration request provided to the first network entity from the second network entity. At 1240, the first network entity provides a cell alteration response to the second network entity. The second network entity obtains the cell alteration response from the first network entity indicating that the one or more cells of the eDU have been reactivated based on the request from the second network entity.

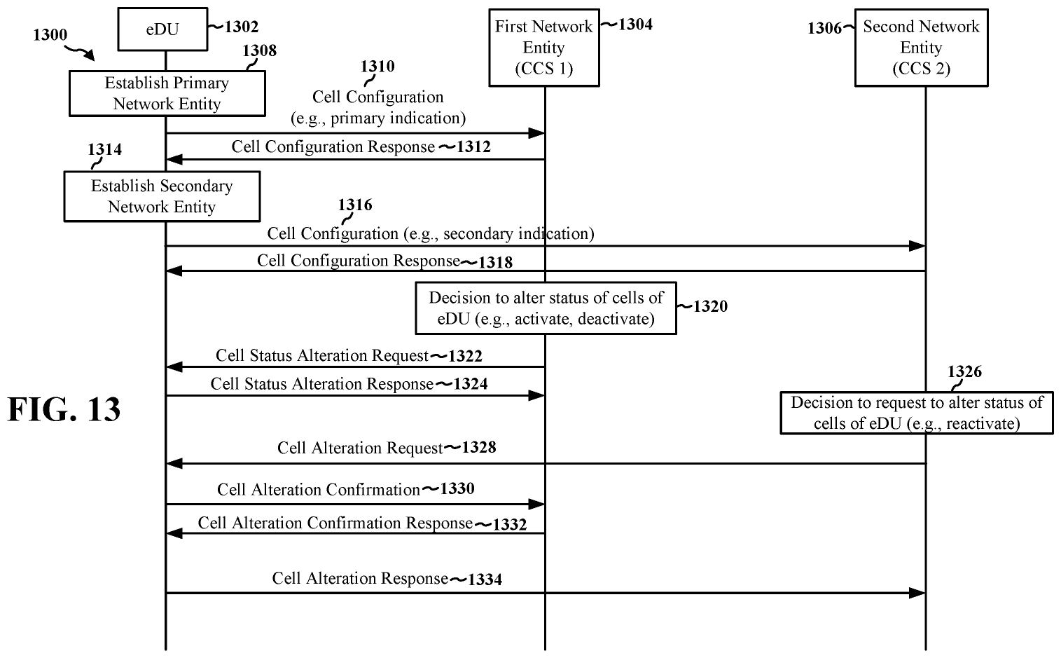

FIG. 13 is a diagram d 1300 illustrating another example of a cell activation/deactivation procedure. The diagram 1300 may include an eDU 1302, a first network entity 1304 (e.g., a first CCS), and a second network entity 1306 (e.g., a second CCS). At 1308, the eDU may establish a primary network entity from a plurality of network entities. For example, the eDU may establish the first network entity as a primary network entity. In such instances, at 1310, the eDU may provide a cell configuration to the first network entity. The first network entity may obtain the cell configuration from the eDU. The cell configuration may indicate to the first network entity that the first network entity is established as the primary network entity. At 1312, the first network entity may provide a cell configuration response to the eDU, which acknowledges that cell configuration. The eDU may obtain the cell configuration response from the first network entity.

At 1314, the eDU may establish a secondary network entity from a plurality of network entities. For example, the eDU may establish the second network entity as a secondary network entity. In such instances, at 1316, the eDU may provide a cell configuration to the second network entity. The second network entity may obtain the cell configuration from the eDU. The cell configuration may indicate to the second network entity that the second network entity is established as the secondary network entity. In some aspects, the cell configuration does not indicate the network entity that has been established as the primary network entity. At 1318, the second network entity may provide a cell configuration response to the eDU, which acknowledges that cell configuration. The eDU may obtain the cell configuration response from the second network entity.

At 1320, the first network entity may decide to alter the status of one or more cells associated with the eDU. For example, the first network entity may decide to activate or deactivate the one or more cells of the eDU based at least one capacity usage. At 1322, the first network entity provides a cell status alteration request to the eDU. The eDU may obtain the cell status alteration request from the first network entity. At 1324, the eDU may provide a cell status alteration response to the first network entity which may acknowledge the request from the first network entity. The first network entity may obtain the cell status alteration response from the eDU.

In some aspects, the second network entity may be configured to directly request to alter the status of one or more cells of the eDU. In such instances, the second network entity, at 1326, may determine to request to alter the status of the one or more cells of the eDU. For example, the second network entity may request for a cell re-activation if additional capacity is needed to accommodate capacity demands. At 1328, the second network entity may provide a cell alteration request to the eDU. The eDU may obtain the cell alteration request from the second network entity. At 1330, the eDU may provide a cell alteration confirmation to the first network entity. The first network entity may obtain the cell alteration confirmation from the eDU. At 1332, the first network entity may provide a cell alteration confirmation response to the eDU that may acknowledge the cell alteration confirmation. At 1334, the eDU may provide a cell alteration response to the second network entity that acknowledges the cell alteration request. The second network entity may obtain the cell alteration response from the eDU. The eDU may determine whether to alter the status (e.g., activate, deactivate, reactivate) the one or more cells based on the request from either the primary network entity (e.g., first network entity) or the secondary network entity (e.g., second network entity). The eDU may consider to grant the requests based on some policies which may be with the eDU or may be provisioned by another entity (e.g., OAM). In some aspects, the eDU may confer or consult with the primary network entity to seek confirmation of the request to alter the status of the one or more cells.

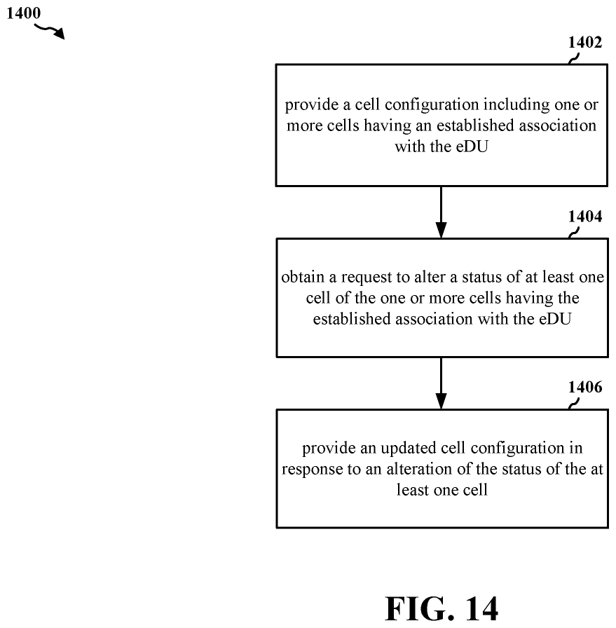

FIG. 14 is a flowchart 1400 of a method of wireless communication at a network entity. The method may be performed by a network entity or network node, or one or more components of a network entity or network node (e.g., a base station 102, 310; a CU 110; a DU 130; an RU 140; the eDU 424, 524, 620, 622, 624, 902, 1020, 1022, 1024, 1102, 1202, 1302; or the network entity 1602). In some instances, the network entity may include an eDU. Although example aspects are described as being performed by an eDU as an example of a network node in a wireless network that transmits and receives signaling with a UE, the network node may also be referred to by other names, such as a base station, a 6G base station, a radio node, a RAN, a RAN node, a 6G RAN, a network entity, or a DU, among others. One or more of the illustrated operations may be omitted, transposed, or contemporaneous. The method may allow for coordination of activation or deactivation of cells.

At 1402, the eDU may provide a cell configuration, as shown in connection with any of FIGS. 9-13. For example, 1402 may be performed by cell component 199 of network entity 1602. The eDU may provide the cell configuration including one or more cells having an established association with the eDU. The eDU may provide the cell configuration to one or more network entities. In some aspects, a service based interface (SBI) or a point-to-point interface may be utilized for signaling between the eDU and one or more network entities. In some aspects, the cell configuration comprises at least one of a serving cell information, RS configurations, PRACH configurations, or configurations related to time, frequency, spatial, or power of the one or more cells.

At 1404, the eDU may obtain a request to alter a status of at least one cell, as shown in connection with any of FIGS. 9-13. For example, 1404 may be performed by cell component 199 of network entity 1602. The eDU may obtain the request to alter the status of the at least one cell of the one or more cells having the established association with the eDU. In some aspects, the eDU may have an association with a first network entity, where the request to alter the status of the at least one cell may be obtained from the first network entity.

At 1406, the eDU may provide an updated cell configuration, as shown in connection with any of FIGS. 9-13. For example, 1406 may be performed by cell component 199 of network entity 1602. The eDU may provide the updated cell configuration to the one or more network entities. The eDU may provide the updated cell configuration in response to an alteration of the status of the at least one cell.

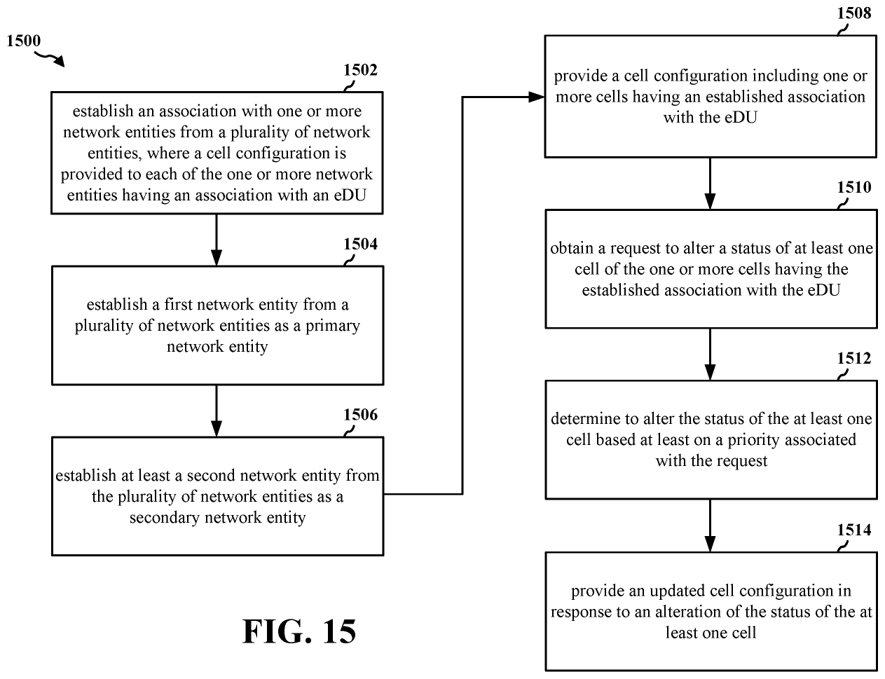

FIG. 15 is a flowchart 1500 of a method of wireless communication at a network entity. The method may be performed by a network entity or network node, or one or more components of a network entity or network node (e.g., a base station 102, 310; a CU 110; a DU 130; an RU 140; the eDU 424, 524, 620, 622, 624, 902, 1020, 1022, 1024, 1102, 1202, 1302; or the network entity 1602). In some instances, the network entity may include an eDU. Although example aspects are described as being performed by an eDU as an example of a network node in a wireless network that transmits and receives signaling with a UE, the network node may also be referred to by other names, such as a base station, a 6G base station, a radio node, a RAN, a RAN node, a 6G RAN, a network entity, or a DU, among others. One or more of the illustrated operations may be omitted, transposed, or contemporaneous. The method may allow for coordination of activation or deactivation of cells.

At 1502, the eDU may establish an association with one or more network entities from a plurality of network entities, as shown in connection with any of FIGS. 9-13. For example, 1502 may be performed by cell component 199 of network entity 1602. The cell configuration may be provided to each of the one or more network entities having the association with the eDU.

At 1504, the eDU may establish a first network entity from a plurality of network entities as a primary network entity, as shown in connection with any of FIGS. 9-13. For example, 1504 may be performed by cell component 199 of network entity 1602. In some aspects, the first network entity may be indicated as being established as the primary network entity. For example, the eDU may provide an indication to the first network entity that the first network entity has been established as the primary network entity. In some aspects, the request to alter the status of the at least one cell may be obtained from the primary network entity.

At 1506, the eDU may establish at least a second network entity from the plurality of network entities as a secondary network entity, as shown in connection with any of FIGS. 9-13. For example, 1506 may be performed by cell component 199 of network entity 1602. Establishment of the primary network entity and the secondary network entity may be based at least on capabilities of the first network entity or based on access rules of the eDU. In some aspects, establishment of the primary network entity and the secondary network entity may be done autonomously by the eDU. In some aspects, the access rules of the eDU may be provisioned by another network entity (e.g., OAM, authorization server, etc.). In some aspects, each second network entity may be indicated as being established as the secondary network entity. For example, the eDU may provide an indication to each second network entity that the second network entity has been established as the secondary network entity. In some aspects, each secondary network entity may be informed that the first network entity is the primary network entity.

At 1508, the eDU may provide a cell configuration, as shown in connection with any of FIGS. 9-13. For example, 1508 may be performed by cell component 199 of network entity 1602. The eDU may provide the cell configuration including one or more cells having an established association with the eDU. The eDU may provide the cell configuration to one or more network entities. In some aspects, an SBI or a point-to-point interface may be utilized for signaling between the eDU and one or more network entities. In some aspects, the cell configuration comprises at least one of a serving cell information, RS configurations, PRACH configurations, or configurations related to time, frequency, spatial, or power of the one or more cells.

At 1510, the eDU may obtain a request to alter a status of at least one cell, as shown in connection with any of FIGS. 9-13. For example, 1510 may be performed by cell component 199 of network entity 1602. The eDU may obtain the request to alter the status of the at least one cell of the one or more cells having the established association with the eDU. In some aspects, the eDU may have an association with a first network entity, where the request to alter the status of the at least one cell may be obtained from the first network entity.

At 1512, the eDU may determine to alter the status of the at least one cell, as shown in connection with any of FIGS. 9-13. For example, 1512 may be performed by cell component 199 of network entity 1602. The eDU may determine to alter the status of the at least one cell based at least on a priority associated with the request. In some aspects, the request to alter the status of the at least one cell may be obtained from one or more network entities. In some aspects, the priority associated with the request may be based at least on a coordination with a primary network entity, wherein the primary network entity authorizes alteration of the status. In some aspects, the priority associated with the request may be based at least on local policies at the eDU, wherein the local policies may be configured or configurable.

At 1514, the eDU may provide an updated cell configuration, as shown in connection with any of FIGS. 9-13. For example, 1514 may be performed by cell component 199 of network entity 1602. The eDU may provide the updated cell configuration to the one or more network entities. The eDU may provide the updated cell configuration in response to an alteration of the status of the at least one cell.

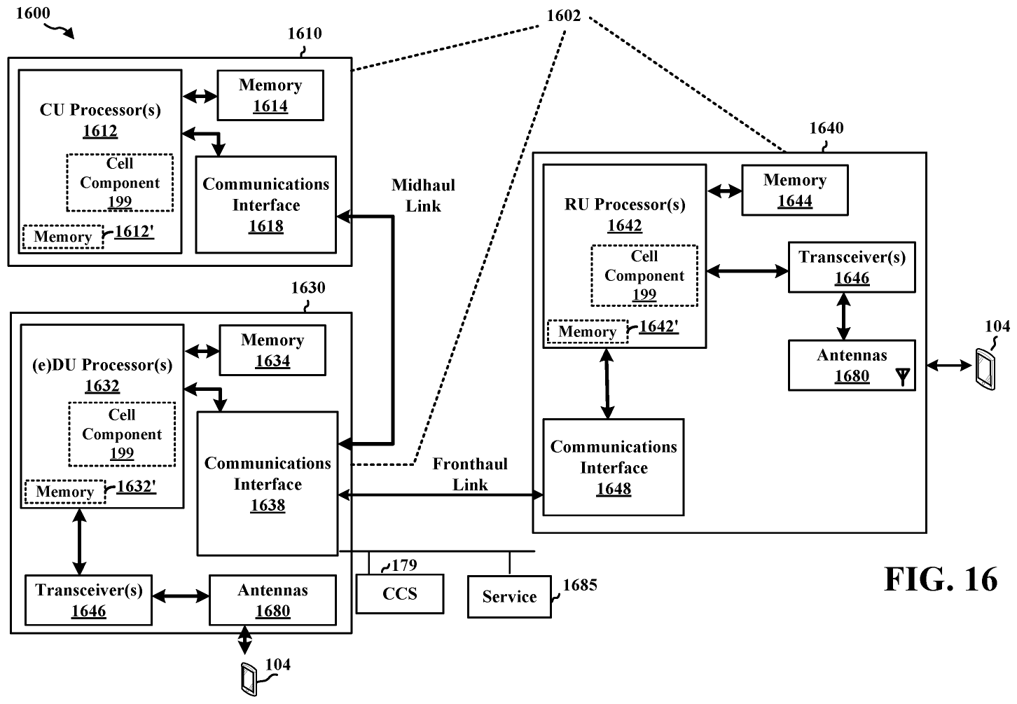

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. In some aspects, the network entity may be an eDU (e.g., DU 1630) in a service-based network architecture including one or more services (e.g., 1685) such as one or more CCS 179. Depending on the layer functionality handled by the cell component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the cell component 199 may be configured to provide a cell configuration including one or more cells having an established association with the eDU; obtain a request to alter a status of at least one cell of the one or more cells having the established association with the eDU; and provide an updated cell configuration in response to an alteration of the status of the at least one cell. The cell component 199 may be within one or more processors of one or more of the CU 1610, DU 1630, and the RU 1640. The cell component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for providing a cell configuration including one or more cells having an established association with the eDU. The network entity may include means for obtaining a request to alter a status of at least one cell of the one or more cells having the established association with the eDU. The network entity may include means for providing an updated cell configuration in response to an alteration of the status of the at least one cell. The network entity may further include means for establishing a first network entity from a plurality of network entities as a primary network entity. The network entity may further include means for establishing at least a second network entity from the plurality of network entities as a secondary network entity. The network entity may further include means for establishing an association with one or more network entities from a plurality of network entities. The cell configuration is provided to each of the one or more network entities having the association with the eDU. The network entity may further include means for determining to alter the status of the at least one cell based at least on a priority associated with the request. The means may be the cell component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

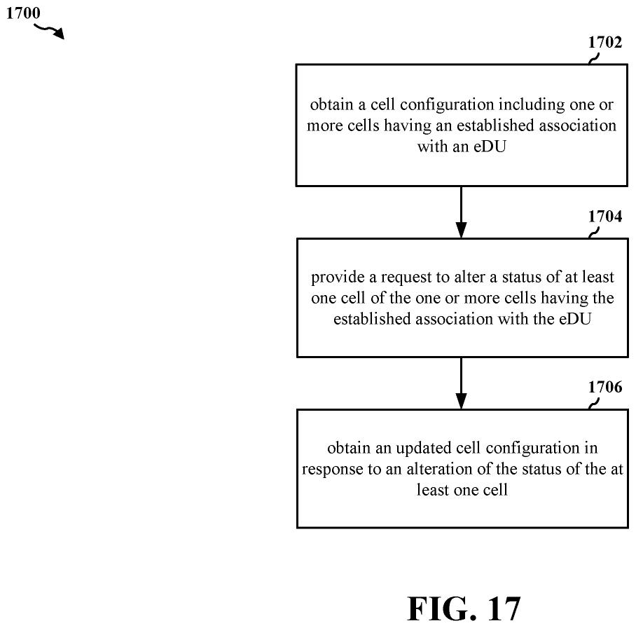

FIG. 17 is a flowchart 1700 of a method of wireless communication of a first network entity or network node. The method may be performed by a service in a service-based network architecture. As an example, the service may be responsible for cell activation and/or deactivation and/or for maintaining cell configurations (e.g., CCS 179, 626, 628; the network entity 904, 1960, first network entity 1026, 1104, 1204, 1304; second network entity 1028, 1106, 1206, 1306). One or more of the illustrated operations may be omitted, transposed, or contemporaneous. The method may allow for coordination of activation or deactivation of cells.

At 1702, the first network entity may obtain a cell configuration, as shown in connection with any of FIGS. 9-13. For example, 1702 may be performed by cell component 198 of network entity 1960. The first network entity may obtain the cell configuration including one or more cells having an established association with a network entity (e.g., eDU). In some aspects, the cell configuration comprises at least one of a serving cell information, RS configurations, PRACH configurations, or configurations related to time, frequency, spatial, or power of the one or more cells.

At 1704, the first network entity may provide a request to alter a status of at least one cell, as shown in connection with any of FIGS. 9-13. For example, 1704 may be performed by cell component 198 of network entity 1960. The first network entity may provide the request to alter the status of the at least one cell of the one or more cells having the established association with the eDU. In some aspects, the first network entity may have an association with the eDU, wherein the request to alter the status of the at least one cell may be provided to the eDU.

At 1706, the first network entity may obtain an updated cell configuration, as shown in connection with any of FIGS. 9-13. For example, 1706 may be performed by cell component 198 of network entity 1960. The first network entity may obtain the updated cell configuration in response to an alteration of the status of the at least one cell. The first network entity may obtain the updated cell configuration from the eDU.

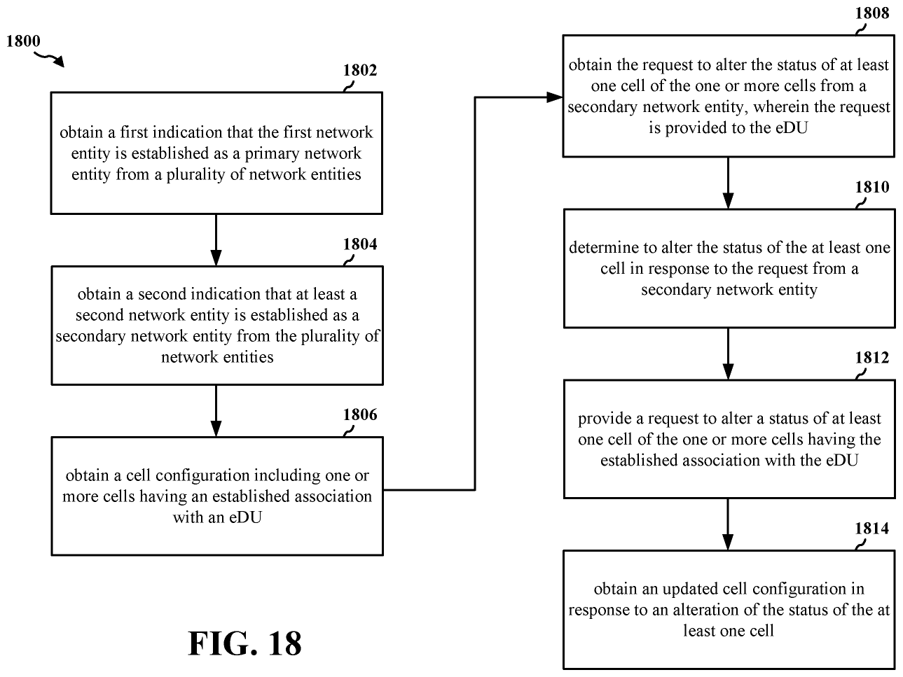

FIG. 18 is a flowchart 1800 of a method of wireless communication of a first network entity or network node. The method may be performed by a service in a service-based network architecture. As an example, the service may be responsible for cell activation and/or deactivation and/or for maintaining cell configurations (e.g., CCS 179, 626, 628; the network entity 904, 1960, first network entity 1026, 1104, 1204, 1304; second network entity 1028, 1106, 1206, 1306). One or more of the illustrated operations may be omitted, transposed, or contemporaneous. The method may allow for coordination of activation or deactivation of cells.

At 1802, the first network entity may obtain a first indication that the first network entity is established as a primary network entity from a plurality of network entities, as shown in connection with any of FIGS. 9-13. For example, 1802 may be performed by cell component 198 of network entity 1960. The first network entity may obtain the first indication that the first network entity is established as the primary network entity after an association is established between the first network entity and an eDU. In some aspects, establishment of the first network entity as the primary network entity may be based at least on capabilities of the first network entity. In some aspects, the request to alter the status of the at least one cell may be provided to the eDU from the primary network entity.

At 1804, the first network entity may obtain a second indication that at least a second network entity is established as a secondary network entity, as shown in connection with any of FIGS. 9-13. For example, 1804 may be performed by cell component 198 of network entity 1960. The secondary network entity may include at least one second network entity from a plurality of network entities.

At 1806, the first network entity may obtain a cell configuration, as shown in connection with any of FIGS. 9-13. For example, 1806 may be performed by cell component 198 of network entity 1960. The first network entity may obtain the cell configuration including one or more cells having an established association with a network entity (e.g., eDU). In some aspects, the cell configuration comprises at least one of a serving cell information, RS configurations, PRACH configurations, or configurations related to time, frequency, spatial, or power of the one or more cells.

At 1808, the first network entity may obtain the request to alter the status of at least one cell of the one or more cells, as shown in connection with any of FIGS. 9-13. For example, 1808 may be performed by cell component 198 of network entity 1960. The first network entity may obtain the request to alter the status (e.g., activate or deactivate) of the at least one cell of the one or more cells from the secondary network entity. The first network entity may provide the request to the eDU. For example, the first network entity may grant or deny the request to alter the status of the at least one cell associated with the eDU. In some aspects, if the request to alter the status of the at least one cell from the second network entity is granted, the first network entity may provide or forward the request to alter the status of the at least one cell to the eDU. The first network entity may inform at least the second network entity that the status of the at least one cell has been altered based on the request. In some aspects, the first network entity may reject the request to alter the at least one cell from the second network entity. The first network entity may reject the request from the second network entity based at least on the first network entity utilizing the at least one cell.

At 1810, the first network entity may determine to alter the status of the at least one cell, as shown in connection with any of FIGS. 9-13. For example, 1810 may be performed by cell component 198 of network entity 1960. The first network entity may determine to alter the status of the at least one cell in response to the request from a secondary network entity.

At 1812, the first network entity may provide a request to alter a status of at least one cell, as shown in connection with any of FIGS. 9-13. For example, 1812 may be performed by cell component 198 of network entity 1960. The first network entity may provide the request to alter the status of the at least one cell of the one or more cells having the established association with the eDU. In some aspects, the first network entity may have an association with the eDU, wherein the request to alter the status of the at least one cell may be provided to the eDU.

At 1814, the first network entity may obtain an updated cell configuration, as shown in connection with any of FIGS. 9-13. For example, 1814 may be performed by cell component 198 of network entity 1960. The first network entity may obtain the updated cell configuration in response to an alteration of the status of the at least one cell. The first network entity may obtain the updated cell configuration from the eDU.

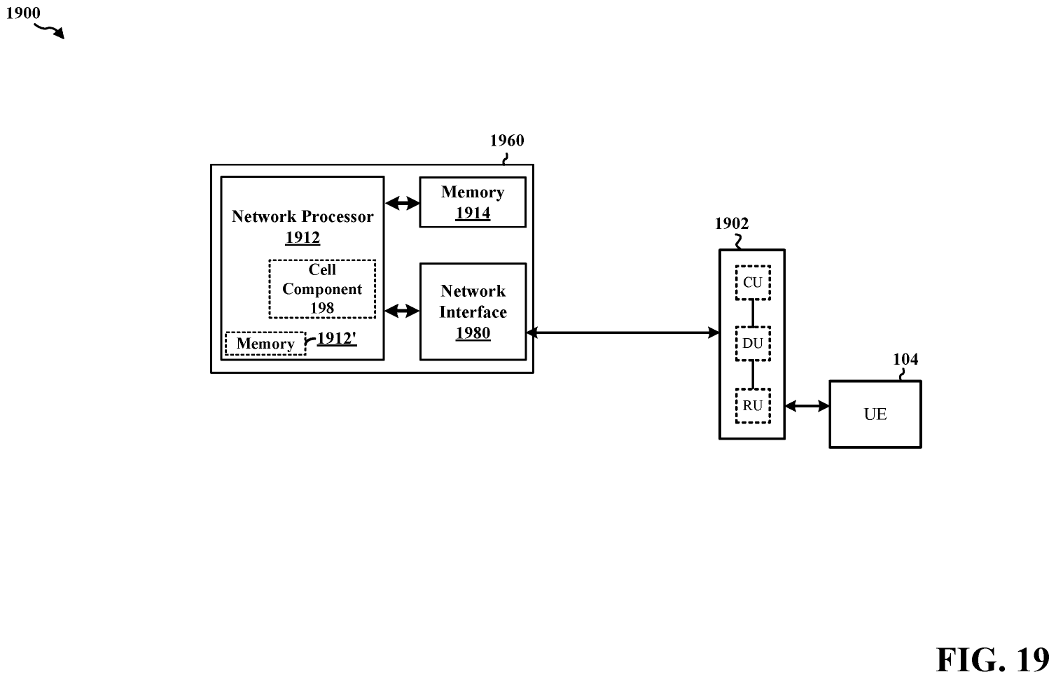

FIG. 19 is a diagram 1900 illustrating an example of a hardware implementation for a network entity 1960 (e.g., CCS 179, 626, 628; the network entity 904; first network entity 1026, 1104, 1204, 1304; second network entity 1028, 1106, 1206, 1306). In one example, the network entity 1960 may be within the core network 120. The network entity 1960 may include at least one network processor 1912. The network processor(s) 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The network processor(s) 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the cell component 198 may be configured to obtain a cell configuration including one or more cells having an established association with an eDU; provide a request to alter a status of at least one cell of the one or more cells having the established association with the eDU; and obtain an updated cell configuration in response to an alteration of the status of the at least one cell. The cell component 198 may be within the network processor(s) 1912. The cell component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1960 may include a variety of components configured for various functions. In one configuration, the network entity 1960 may include means for obtaining a cell configuration including one or more cells having an established association with an eDU. The network entity includes means for providing a request to alter a status of at least one cell of the one or more cells having the established association with the eDU. The network entity include means for obtaining an updated cell configuration in response to an alteration of the status of the at least one cell. The network entity further includes means for obtaining a first indication that the first network entity is established as a primary network entity from a plurality of network entities. The network entity further includes means for obtaining a second indication that at least a second network entity is established as a secondary network entity from the plurality of network entities. The network entity further includes means for obtaining the request to alter the status of at least one cell of the one or more cells from a secondary network entity, wherein the request is provided to the eDU. The network entity further includes means for determining to alter the status of the at least one cell in response to the request from a secondary network entity. The means may be the cell component 198 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at an eDU comprising providing a cell configuration including one or more cells having an established association with the eDU; obtaining a request to alter a status of at least one cell of the one or more cells having the established association with the eDU; and provide an updated cell configuration in response to an alteration of the status of the at least one cell.

Aspect 2 is the method of aspect 1, further includes that the cell configuration comprises at least one of a serving cell information, RS configurations, PRACH configurations, or configurations related to time, frequency, spatial, or power of the one or more cells.

Aspect 3 is the method of any of aspects 1 and 2, further includes that the eDU has an association with a first network entity, wherein the request to alter the status of the at least one cell is obtained from the first network entity.

Aspect 4 is the method of any of aspects 1-3, further including establishing a first network entity from a plurality of network entities as a primary network entity; and establishing at least a second network entity from the plurality of network entities as a secondary network entity.

Aspect 5 is the method of any of aspects 1-4, further includes that establishment of the primary network entity and the secondary network entity is based at least on capabilities of the first network entity or based on access rules of the eDU.

Aspect 6 is the method of any of aspects 1-5, further includes that the first network entity is indicated as being established as the primary network entity, wherein each secondary network entity is indicated as being established as the secondary network entity.

Aspect 7 is the method of any of aspects 1-6, further includes that each secondary network entity is informed that the first network entity is the primary network entity.

Aspect 8 is the method of any of aspects 1-7, further includes that the request to alter the status of the at least one cell is obtained from the primary network entity.

Aspect 9 is the method of any of aspects 1-8, further including establishing an association with one or more network entities from a plurality of network entities, wherein the cell configuration is provided to each of the one or more network entities having the association with the eDU.

Aspect 10 is the method of any of aspects 1-9, further including determine to alter the status of the at least one cell based at least on a priority associated with the request.

Aspect 11 is the method of any of aspects 1-10, further includes that the request to alter the status of the at least one cell is obtained from one or more network entities.

Aspect 12 is the method of any of aspects 1-11, further includes that the priority associated with the request is based at least on a coordination with a primary network entity, wherein the primary network entity authorizes alteration of the status.

Aspect 13 is the method of any of aspects 1-12, further includes that the priority associated with the request is based at least on local policies at the eDU, wherein the local policies are configured or configurable.

Aspect 14 is the method of any of aspects 1-13, further includes that a SBI or a point-to-point interface is utilized for signaling between the eDU and one or more network entities.

Aspect 15 is an apparatus for wireless communication at an eDU including at least one processor coupled to a memory and at least one transceiver, the at least one processor configured to implement any of aspects 1-14.

Aspect 16 is an apparatus for wireless communication at an eDU including means for implementing any of aspects 1-14.

Aspect 17 is a computer-readable medium storing computer executable code, where the code when executed by a processor causes the processor to implement any of aspects 1-14.

Aspect 18 is a method of wireless communication at a first network entity comprising obtaining a cell configuration including one or more cells having an established association with an eDU; providing a request to alter a status of at least one cell of the one or more cells having the established association with the eDU; and obtaining an updated cell configuration in response to an alteration of the status of the at least one cell.

Aspect 19 is the method of aspect 18, further includes that the cell configuration comprises at least one of a serving cell information, RS configurations, PRACH configurations, or configurations related to time, frequency, spatial, or power of the one or more cells.

Aspect 20 is the method of any of aspects 18 and 19, further includes that the first network entity has an association with the eDU, wherein the request to alter the status of the at least one cell is provided to the eDU.

Aspect 21 is the method of any of aspects 18-20, further includes obtaining a first indication that the first network entity is established as a primary network entity from a plurality of network entities.

Aspect 22 is the method of any of aspects 18-21, further including obtaining a second indication that at least a second network entity is established as a secondary network entity from the plurality of network entities.

Aspect 23 is the method of any of aspects 18-22, further includes that establishment of the first network entity as the primary network entity is based at least on capabilities of the first network entity.

Aspect 24 is the method of any of aspects 18-23, further includes that the request to alter the status of the at least one cell is provided to the eDU from the primary network entity.

Aspect 25 is the method of any of aspects 18-24, further including obtaining the request to alter the status of at least one cell of the one or more cells from a secondary network entity, wherein the request is provided to the eDU.

Aspect 26 is the method of any of aspects 18-25, further including determining to alter the status of the at least one cell in response to the request from a secondary network entity.

Aspect 27 is an apparatus for wireless communication at a first network entity including at least one processor coupled to a memory and at least one transceiver, the at least one processor configured to implement any of aspects 18-26.

Aspect 28 is an apparatus for wireless communication at a first network entity including means for implementing any of aspects 18-26.

Aspect 29 is a computer-readable medium storing computer executable code, where the code when executed by a processor causes the processor to implement any of aspects 18-26.

What is claimed is:

1. An apparatus for wireless communication at an enhanced distributed unit (eDU), comprising:
at least one memory; and
at least one processor coupled to the at least one memory and, based at least in part on information stored in the at least one memory, the at least one processor, individually or in any combination, is configured to cause the apparatus to:
provide a cell configuration including one or more cells having an established association with the eDU;
obtain a request to alter a status of at least one cell of the one or more cells having the established association with the eDU; and
provide an updated cell configuration in response to an alteration of the status of the at least one cell.

2. The apparatus of claim 1, further comprising a transceiver coupled to the at least one processor, the transceiver being configured to:
provide the cell configuration including the one or more cells having the established association with the eDU;
obtain the request to alter the status of the at least one cell of the one or more cells having the established association with the eDU; and
provide the updated cell configuration in response to the alteration of the status of the at least one cell.

3. The apparatus of claim 1, wherein the cell configuration comprises at least one of a serving cell information, reference signal (RS) configurations, physical random access channel (PRACH) configurations, or configurations related to time, frequency, spatial, or power of the one or more cells.

4. The apparatus of claim 1, wherein the eDU has an association with a first network entity, wherein the request to alter the status of the at least one cell is obtained from the first network entity.

5. The apparatus of claim 1, wherein the at least one processor is configured to:
establish a first network entity from a plurality of network entities as a primary network entity; and
establish at least a second network entity from the plurality of network entities as a secondary network entity.

6. The apparatus of claim 5, wherein establishment of the primary network entity and the secondary network entity is based at least on capabilities of the first network entity or based on access rules of the eDU.

7. The apparatus of claim 5, wherein the first network entity is indicated as being established as the primary network entity, wherein each secondary network entity is indicated as being established as the secondary network entity.

8. The apparatus of claim 7, wherein each secondary network entity is informed that the first network entity is the primary network entity.

9. The apparatus of claim 5, wherein the request to alter the status of the at least one cell is obtained from the primary network entity.

10. The apparatus of claim 5, wherein the at least one processor is configured to:
establish an association with one or more network entities from a plurality of network entities, wherein the cell configuration is provided to each of the one or more network entities having the association with the eDU.

11. The apparatus of claim 5, wherein the at least one processor is configured to:
determine to alter the status of the at least one cell based at least on a priority associated with the request.

12. The apparatus of claim 11, wherein the request to alter the status of the at least one cell is obtained from one or more network entities.

13. The apparatus of claim 11, wherein the priority associated with the request is based at least on a coordination with a primary network entity, wherein the primary network entity authorizes alteration of the status.

14. The apparatus of claim 11, wherein the priority associated with the request is based at least on local policies at the eDU, wherein the local policies are configured or configurable.

15. The apparatus of claim 1, wherein a service based interface (SBI) or a point-to-point interface is utilized for signaling between the eDU and one or more network entities.

16. A method of wireless communication at an enhanced distributed unit (eDU), comprising:
providing a cell configuration including one or more cells having an established association with the eDU;
obtaining a request to alter a status of at least one cell of the one or more cells having the established association with the eDU; and
providing an updated cell configuration in response to an alteration of the status of the at least one cell.

17. The method of claim 16, further comprising:
establishing a first network entity from a plurality of network entities as a primary network entity; and
establishing at least a second network entity from the plurality of network entities as a secondary network entity.

18. The method of claim 16, further comprising:
determining to alter the status of the at least one cell based at least on a priority associated with the request.

19. An apparatus for wireless communication at a first network entity, comprising:
at least one memory; and
at least one processor coupled to the at least one memory and, based at least in part on information stored in the at least one memory, the at least one processor, individually or in any combination, is configured to cause the apparatus to:
obtain a cell configuration including one or more cells having an established association with an enhanced distributed unit (eDU);
provide a request to alter a status of at least one cell of the one or more cells having the established association with the eDU; and
obtain an updated cell configuration in response to an alteration of the status of the at least one cell.

20. The apparatus of claim 19, further comprising a transceiver coupled to the at least one processor, the transceiver being configured to:
obtain the cell configuration including the one or more cells having the established association with the eDU;
provide the request to alter the status of the at least one cell of the one or more cells having the established association with the eDU; and
obtain the updated cell configuration in response to the alteration of the status of the at least one cell.

21. The apparatus of claim 19, wherein the cell configuration comprises at least one of a serving cell information, reference signal (RS) configurations, physical random access channel (PRACH) configurations, or configurations related to time, frequency, spatial, or power of the one or more cells.

22. The apparatus of claim 19, wherein the first network entity has an association with the eDU, wherein the request to alter the status of the at least one cell is provided to the eDU.

23. The apparatus of claim 19, wherein the at least one processor is configured to:
obtain a first indication that the first network entity is established as a primary network entity from a plurality of network entities.

24. The apparatus of claim 23, wherein the at least one processor is configured to:
obtain a second indication that at least a second network entity is established as a secondary network entity from the plurality of network entities.

25. The apparatus of claim 23, wherein establishment of the first network entity as the primary network entity is based at least on capabilities of the first network entity.

26. The apparatus of claim 23, wherein the request to alter the status of the at least one cell is provided to the eDU from the primary network entity.

27. The apparatus of claim 23, wherein the at least one processor is configured to:
obtain the request to alter the status of at least one cell of the one or more cells from a secondary network entity, wherein the request is provided to the eDU.

28. The apparatus of claim 23, wherein the at least one processor is configured to:
determine to alter the status of the at least one cell in response to the request from a secondary network entity.

29. A method of wireless communication at a first network entity, comprising:
obtaining a cell configuration including one or more cells having an established association with an enhanced distributed unit (eDU);
providing a request to alter a status of at least one cell of the one or more cells having the established association with the eDU; and
obtaining an updated cell configuration in response to an alteration of the status of the at least one cell.

30. The method of claim 29, further comprising:
obtaining a first indication that the first network entity is established as a primary network entity from a plurality of network entities.
